(19) United States
(12) Patent Application Publication
(10) Pub. No.: US 2025/0026086 A1
(43) Pub. Date: Jan. 23, 2025

(54) System and Methods for Creating Precision Three Dimensional Surfaces from Two Dimensional Material

(71) Applicant: L'Garde, Inc., Tustin, CA (US)

(72) Inventors: Jason G. White, Lake Elsinore, CA (US); Bryan Yamamont, Tustin, CA (US); David Friese, Tustin, CA (US); Michael Gattulli, Costa Mesa, CA (US)

(21) Appl. No.: 18/906,655

(22) Filed: Oct. 4, 2024

Related U.S. Application Data
(63) Continuation of application No. PCT/US2023/017540, filed on Apr. 5, 2023.
(60) Provisional application No. 63/362,461, filed on Apr. 5, 2022.

(51) Int. Cl. B29C 65/00

(52) U.S. Cl. CPC B29C 66/49; B29C 66/02241; B29C 66/43; B29C 66/95

(57) ABSTRACT

Systems and methods are provided herein for making a high precision three-dimensional surface by cutting panels having curved outer edges, aligning the edges of adjacent panels on a mandrel having a curved surface, illuminating the mandrel to show space between the panels, adjusting the panels to bring into precision alignment, using a magnifier and micrometer to readjust the position of the panels relative to each other for a more precise alignment, and adhering the panels together in a precise orientation for creating the high precision three dimensional surface.

### PRIORITY AND CROSS-REFERENCE TO RELATED APPLICATIONS

This application claims priority as a continuation of International Application Number PCT/US2023/017540, filed Apr. 5, 2023, which claims priority to U.S. Provisional Patent Application No. 63/362,461 filed Apr. 5, 2022, each of which is incorporated herein in its entirety by reference.

### BACKGROUND

Reflectors are used often in space applications. They may form the basis for collectors, antennas, sails, and other application. However, some applications require high precision of the surface shape to achieve a desired result.

Space applications also benefit from lowering weight requirements and/or provided deployable structures.

Currently, there is no good way to manufacture highly precise, curved, thin film reflectors.

### SUMMARY

Systems and methods are described herein for creating precision three dimensional surfaces from two dimensional materials.

### DRAWINGS

FIGS. 1-21 illustrate exemplary embodiments and component parts of system at various steps for creating thin film surfaces made of multiple panels according to embodiments of the invention.

FIG. 1 illustrates an exemplary template for use in cutting portions of the two dimensional thin film materials for creating the thin film three dimensional surface according to embodiments described herein.

FIG. 2 illustrates an exemplary two dimensional thin film cut using the template of FIG. 1.

FIG. 3 illustrates an exemplary portion of the template of FIG. 1.

FIG. 4 illustrates an exemplary two dimensional cut thin film.

FIG. 5 illustrates adjacent portions of the two dimensional cut thin film portions positioned next to each other to illustrate the wedge configuration of the material.

FIG. 6 illustrates a plurality of cut two dimensional thin films for use in creating the thin film three-dimensional surface.

FIG. 7 illustrates an exemplary mandrel for positioning and combining adjacent portions of two, two-dimensional cut thin film portions.

FIG. 8 illustrates a portion of the mandrel of FIG. 7.

FIG. 9 illustrates a portion of the mandrel of FIG. 9.

FIG. 10 illustrates the mandrel of FIG. 7 with two thin films positioned in the troughs of the mandrel in preparation of combining adjacent two-dimensional cut thin film portions.

FIG. 11 illustrates a portion of an exemplary portion of the mandrel with one two-dimensional cut thin film is being positioned thereon.

FIG. 12 illustrates a portion of an exemplary repositioning of one of the two-dimensional cut thin film on the mandrel using a tool.

FIG. 13 illustrates a portion of an exemplary positioning of one of the two-dimensional cut thin film on the mandrel.

FIG. 14 illustrates a portion of the first two-dimensional cut thin film positioned on the mandrel of FIG. 7.

FIG. 15 illustrates a portion of the initial positioning of the second of the adjacent two-dimensional cut thin film positioned on the mandrel of FIG. 7.

FIG. 16 illustrates a portion of the exemplary positioning of adjacent two-dimensional cut thin films on the mandrel.

FIG. 17 illustrates a portion of repositioning of the other of the two-dimensional cut thin film on the mandrel using the tool.

FIG. 18 illustrates a portion of the positioned two-dimensional cut thin films on the mandrel being observed with a magnifier device.

FIG. 19 illustrates a view of the mandrel and two-dimensional cut thin film on the mandrel through the magnifier device.

FIG. 20 illustrates the mandrel in a closed position for curing the adjacent two-dimensional cut thin films on the mandrel described herein.

FIG. 21 illustrates an exemplary finished three-dimensional thin film membrane according to embodiments described herein.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention and are not limiting of the present invention nor are they necessarily drawn to scale.

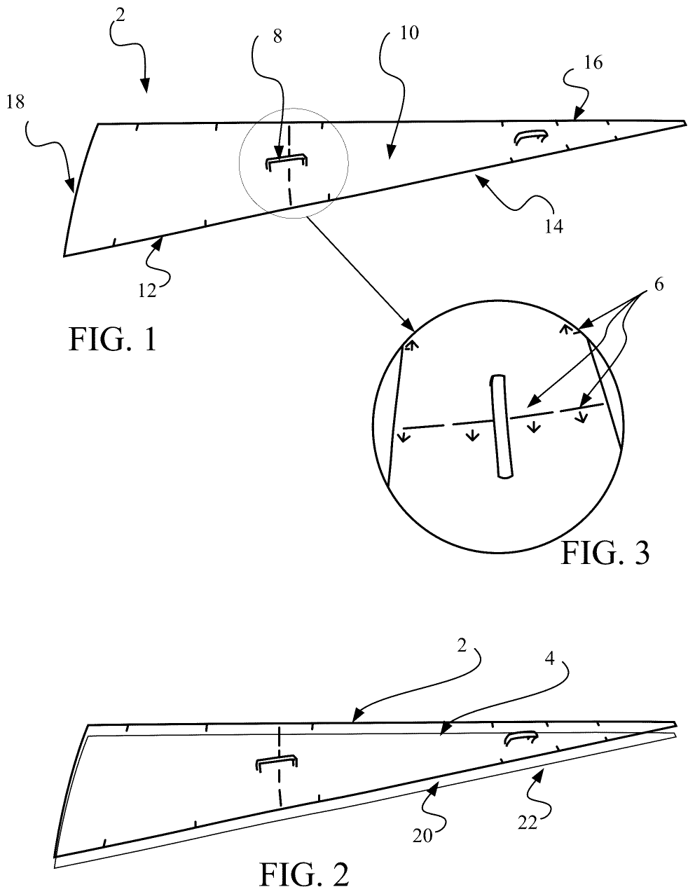

FIG. 1 illustrates an exemplary template 2 for obtaining a pattern to be used with methods of the present disclosure. The template 2 includes a pattern 10 having a desired perimeter 12 for cutting a panel of a desired shape. The perimeter in the exemplary embodiment comprises a first side 14, a second side 16, and an end 18. The perimeter 12 is generally in the shape of a wedge or pie shape. In an exemplary embodiment, the sides are calculated so that when the panels are coupled together according to embodiments described herein, the overall shape of the resulting connected panels defines a three dimensional approximate curved or concave surface.

Exemplary embodiments described herein may use two dimensional sheets of material that is cut in a two-dimensional pattern to form a panel. The pattern may be designed such that when adjacent panels are coupled together at their edges, a three-dimensional surface is formed. Lateral edges (those corresponding to the pattern edges 14, 16), those that are coupled between adjacent panels, may be curved to accommodate the formation of the three-dimensional shape. In an exemplary embodiment, the perimeter is designed such that adjacent panels do not overlap. When adjacent panels overlap, the surface may be deformed, and the desired precision of the resulting surface may be diminished.

FIG. 2 illustrates an exemplary panel 4 after it has been cut by the template 2. In an exemplary embodiment of a method according to the present description, a sheet of material may be laid flat and the template 2 to provide the pattern 10 positioned thereon. The material, which may be a thin film and/or reflective material, may be cut at the perimeter 12 of the pattern 10. The cut sheet of material may form a panel 20 with a perimeter 22 that corresponds to the perimeter 12 of the pattern 10. In an exemplary embodiment, the template 2 is made of a metal that may be machined to a desired precision. The template 2 may include handles 8 to assist in positioning the pattern 10 on or off a sheet of material.

FIG. 3 illustrates a portion of the template 2 to provide a close-up view of the pattern 10. As illustrated, one or more slits 6 or openings may be formed in the template 2 as part of the pattern 10. These openings may permit the fabricator to put markings on the material below in desired locations. These markings may be used for alignment as described more fully herein.

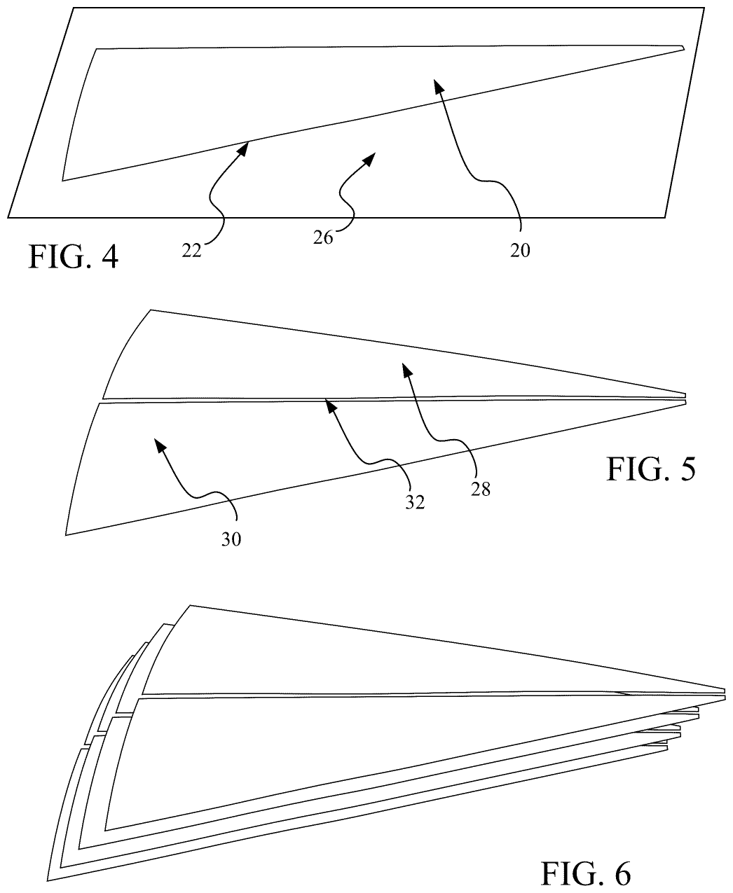

FIG. 4 illustrates an exemplary panel after being cut and marked. The panel 20 may be positioned under a clear cover 26 to flatten the panel 20. When flattened, the panel 20 may be measured to quality check the cut of the perimeter 22 within a desired tolerance. The tolerance of the panel may be the same or different than the tolerance of the pattern 10 of the template 2.

Exemplary methods according to embodiments described herein may therefore include marking the sheet of material and/or the panel before, during, or after the panel is cut based on the pattern. The panel may thereafter be measured to check the cut and tolerances of the perimeter 22 if the panel. The panel may be positioned under a flat, transparent cover in order to retain the panel in a desired and flat orientation for measurement. The transparent cover may also protect the material during the measurement process.

FIGS. 5-6 illustrate exemplary sections of the three-dimensional surface created from two panels, a first panel 28 and a second panel 30 joined at a seam 32. The method of manufacturing may include making a plurality of sections comprising a first panel and a second panel joined at a seam. These sections may thereafter be coupled together as the panels are to form larger sections and ultimately the three-dimensional surface. The panels may also be formed serially such that one panel is joined to a section that continues to grow based on the addition of previous panels. The panels may therefore be coupled to one another in any order.

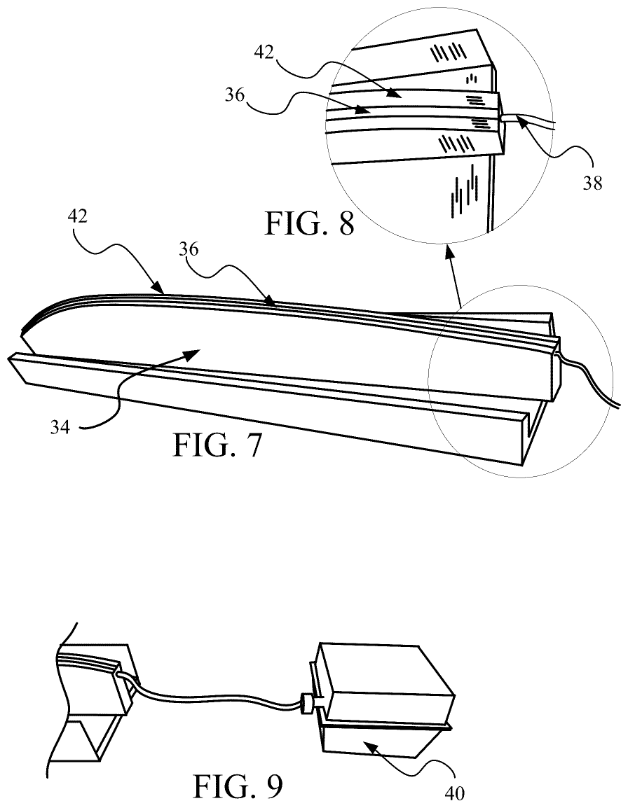

FIG. 7 illustrates an exemplary mandrel 34 for coupling two panels together. In an exemplary embodiment, a first panel is positioned on the mandrel; and then the first panel is aligned on the mandrel. A second panel is then also positioned on the mandrel; and then the second panel is aligned on the mandrel. When positioned, the first panel is separated by a gap from the second panel, wherein the separation distance between the first panel and the second panel is controlled to a desired limited distance within a tolerance such that the resulting three-dimensional surface retains a desired form within another tolerance. Each of the tolerances of the pattern of the template, mandrel, perimeter, separation gap, or other tolerances described herein may be the same, different, or some combination thereof. The desired tolerances can be determined based on the desired resulting three-dimensional shape and the tolerance of that surface structure. The first panel is therefore positioned adjacent the second panel without the panels overlapping on the mandrel 34.

FIGS. 8-9 are partial component views of the mandrel 34 according to embodiments described herein. The mandrel 34 may comprise a light 36 internal to the mandrel that may shine through the mating surface 42 of the mandrel. The light may permit the gap between the first panel and the second panel to be more easily identified. The mandrel 34 may include a light conduit 38 and a housing 40. The housing may include a light source, power, and other electronics used to generate the light for the light 36 within the mandrel.

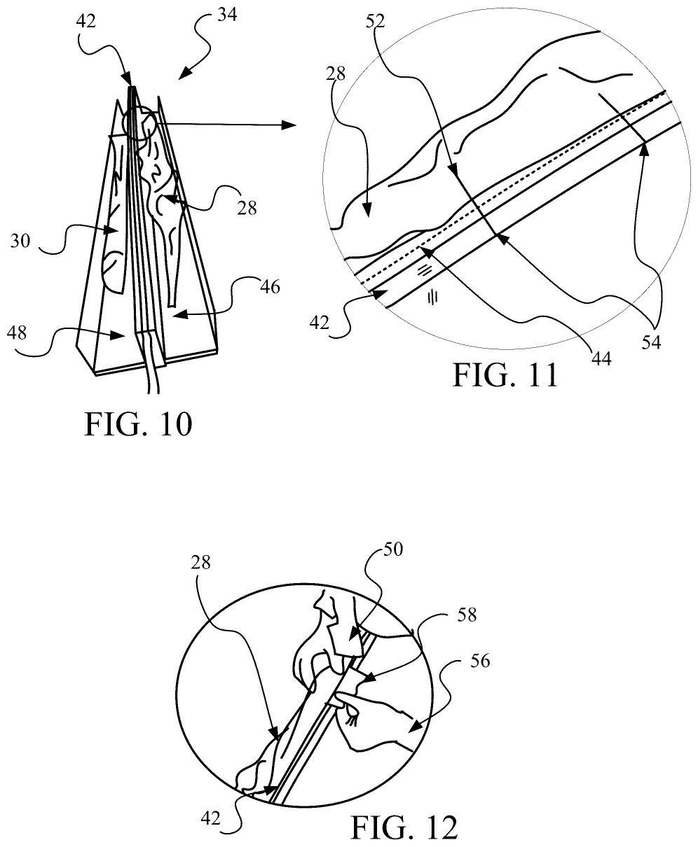

FIG. 10 illustrates an exemplary view of the mandrel 34 showing the mating surface 42. The mating surface 42 may include a frictional surface configured to retain the material of the panel in a desired location. The mating surface may be, for example, formed of a rubber or other pliable material that may attract or retain the material of the panel when the material is in contact or pressed against the mating surface. As seen in FIG. 7, the mating surface may comprise a curved or three-dimensional shape. The mating surface may be in the shape approximating the three-dimensional surface shape at a seam of adjacent panels. Because the lateral edges of the panel may be curved, adjacent panels may not be directly coupled on a two-dimensional surface without jeopardizing the desired tolerance of the resulting three-dimensional surface.

As seen in the blow-up view of FIG. 11, the mating surface may have one or more reference lines or marks 44, 54 to assist in the alignment of a panel to the mandrel and/or to another panel. As illustrated, the mating surface 42 comprises a reference marking 44 extending longitudinally along the mandrel. The reference marking 44 is straight in two dimensions for the alignment of a lateral edge of a first panel on a first side of the reference marking, and a lateral edge of a second panel on a second side of the reference marking. As illustrated, the mating surface 42 comprises a reference marking 54 extending laterally across the mandrel mating surface.

FIG. 10 illustrate a first panel 28 and second panel 30 positioned on the mandrel within troughs on opposing sides of the mating surface 42 of the mandrel to retain the material during the attachment process in preparation of being aligned on the mandrel according to embodiments described herein. The mandrel may include a first trough 46 and a second trough 48 for positioning panels therein. The troughs may be positioned on opposing sides of the mating surface may be hold the material of a panel that is not on the mating surface. The trough may have an exterior outside wall to protect the panels during assembly.

Methods of assembly according to embodiments described herein may include positioning a first panel 28 in a first trough 46 of the mandrel and positioning a second panel 30 in a second trough 48 of the mandrel. The panels may be longitudinally positioned in the troughs such that they extend along a length of the mating surface. Thereafter, a person may position a first edge of the first panel on the mating surface and position a first edge of the second panel on the mating surface.

FIG. 12 illustrates the positioning of the first panel on the mating surface. A user may use magnification glasses 50 to align the first edge of the first panel on the mating surface in relationship to the reference marking on the mating surface. The user may try to position the first edge of the first panel as close to the reference marking as possible without crossing the reference marking on the mating surface.

FIG. 11 illustrates a partial component view of the mandrel and its mating surface 42 with a first panel 28 partially positioned thereon. As described herein with reference to the pattern, one or more reference markings may be made on the panel through openings on the template. As illustrated, the first panel 28 may include a first reference marking 52 that was drawn onto the material surface during its cutting step. The mating surface 42 may also include a second reference marking 54. The second reference marking 54 may be transverse across the mating surface. The second reference marking 54 may be perpendicular to the reference marking 44.

The method of manufacture according to embodiments described herein may include positioning the first panel on the mating surface. The panel may be positioned on the mating surface starting with aligning the reference markings. A second reference marking may be used to identifying a starting point of the panel on the mandrel to align a longitudinal length of the panel to the mandrel. A first reference marking may be used to then align an edge of the panel along the length of the mandrel, as described herein. After alignment of the starting point, a user 56 may continue to align the first panel 28 to the mating surface 42 along the reference marking 44 that ends along the length of the mandrel. The user may use magnifying glasses to assist in the alignment of the panel to the mating surface, as described herein.

FIG. 12 illustrates an exemplary partial view of the manufacturing process showing the fine alignment of the first panel 28 to the mating surface 42 according to embodiments described herein. After the gross alignment of the first panel to the mating surface, the panel may be repositioned to more precisely position the panel to the mating surface. A separator 58 may be used to separate the panel from the mating surface. The separator 58 may be a thin piece of material that is frictionally reduced or not attracted to either the mating surface 42 and/or the panel 28 such that the panel may be more easily moved relative to the mating surface when the separator is positioned between the panel and the mating surface. The separator is preferably a thin piece so that it can be slid between the panel and the mating surface. The separator preferably has a width as large as the portion of the panel in contact with the mating surface such that an entire width from the edge of the panel to the edge of the mating surface can be separated and permit realignment of the edge of the panel relative to the mating surface. In an exemplary embodiment, the separator is also flexible to permit easier manipulation and movement of the separator. In an exemplary embodiment, the separator is also sufficient stiff to permit the separator to slide along and between the panel and the mating surface without buckling.

For fine alignment, the user may insert a separator between the panel and the mating surface. The user may then move the panel relative to the mating surface, such that the edge of the panel is in a more precise position relative to the reference marking on the mating surface. The light within the mandrel may be on to increase the visualization of the reference marking and/or the edge of the panel for realignment.

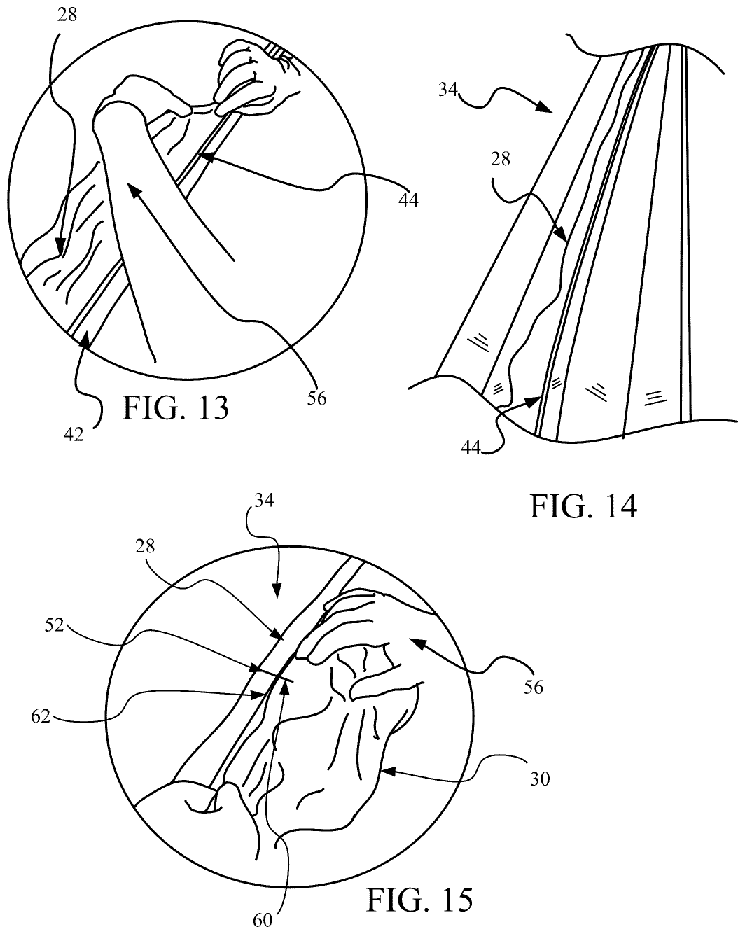

FIG. 13 illustrates exemplary partial component view of the mandrel with the first two-dimensional thin film material being positioned thereon. FIG. 14 illustrates a portion of the mandrel with the first two-dimensional thin film material positioned on the mandrel in alignment with the reference marking 44.

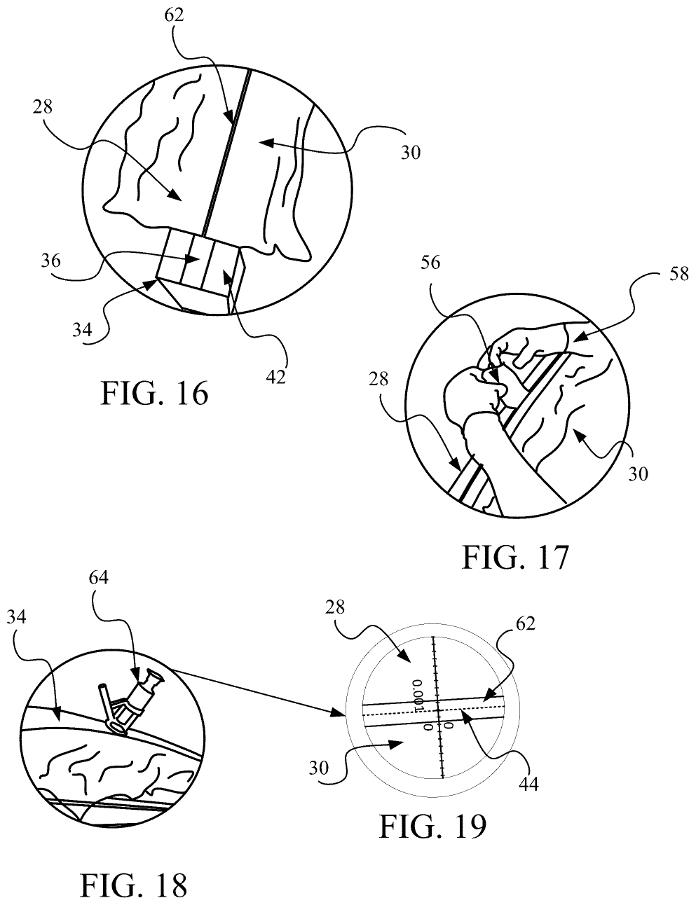

FIGS. 15-17 illustrate exemplary partial component views of the mandrel 34 during the step of positioning the second panel 30 relative to the first panel 26 and/or the reference marking of the mandrel and/or the first panel 52, 54. The second panel 30 may be positioned on the mandrel 34 similar to the first panel. As illustrated, a user 56 may start at a reference marking 60 on the second panel 30 and align the reference marking at a point along the length of the mandrel such as at the reference marking 54 and/or the reference marking 52 of the first panel 28. Thereafter, the user may align an edge of the second panel relative to the edge of the first panel and/or the reference marking on the mandrel's mating surface. In an exemplary embodiment, the second panel 30 is positioned relative to the first panel 28 such that the second panel does not overlap the first panel. The first panel is positioned next to the first panel such that a distance between the first panel and the second panel is from 0 to a desired distance. The desired distance may be based on the precision of the resulting three-dimensional surface. A gap 62 may therefore be seen using the light between the first panel and the second panel. Similar to the placement of the first panel, the second panel may be grossly positioned, and then finely repositioned using a separator 58. The separator 58 may be positioned between the second panel and the mating surface and on top of the first panel so that the first panel stays in contact with the mating surface. An edge of the second panel may be repositioned relative to the first panel and/or the mating surface by laterally moving the edge of the second panel across the mating surface and separator. In an exemplary embodiment, the edge of the panel is positioned relative to the mating surface at or adjacent to the terminal end of the separator and the separator is slid along a longitudinal length of the panel. This method of readjustment may also be used with the first panel.

FIGS. 17-18 illustrate the relative positioning of the first panel and the second panel on the mating surface after fine realignment. The panels may be precisely realigned a third and/or final time to ensure the positioning of the panels relative to each other within a desired tolerance.

FIGS. 18-19 illustrate exemplary partial component views of the system during a precision realignment of the panels. As illustrated a microscope (or other magnifier) 64 with a micrometer may be used to measure the separation of the first panel 28 from the second panel 30. The fabricator may then reposition the first panel 28 to the second panel 30 to maintain the gap 62 within the desired distance. The fabricator may start at one end of the mandrel and move along the gap to the other end of the mandrel repositioning the first and/or the second panel to precisely align the panels relative to each other. The internal light of the mandrel may be turned off during this step and/or a light of the magnifier and/or micrometer used to illuminate the panel(s) and/or the gap.

FIG. 19 illustrates an exemplary view through the magnifier at the micrometer to show the panels at different separation gaps. The gap may originally be outside of the tolerance, and the panel(s) realigned such that the gap is then within the tolerance.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range. Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

Once the first panel 28 is precisely aligned relative to the second panel 30, the two panels may be adhered to each other. Different methods may be used to join the panels together. In an exemplary embodiment, a scam may be made by positioning another layer of material over the edge of the first panel and the edge of the second panel and an adhesive or other bonding agent used to couple the first panel and the second panel to the overlaid material. The adhesive may therefore be positioned on a region of the first panel and/or a region of the second panel adjacent or at their respective edges and the overlaid material positioned thereof. The overlaid material may also or alternatively include the adhesive and then overlaid on the first and second panels.

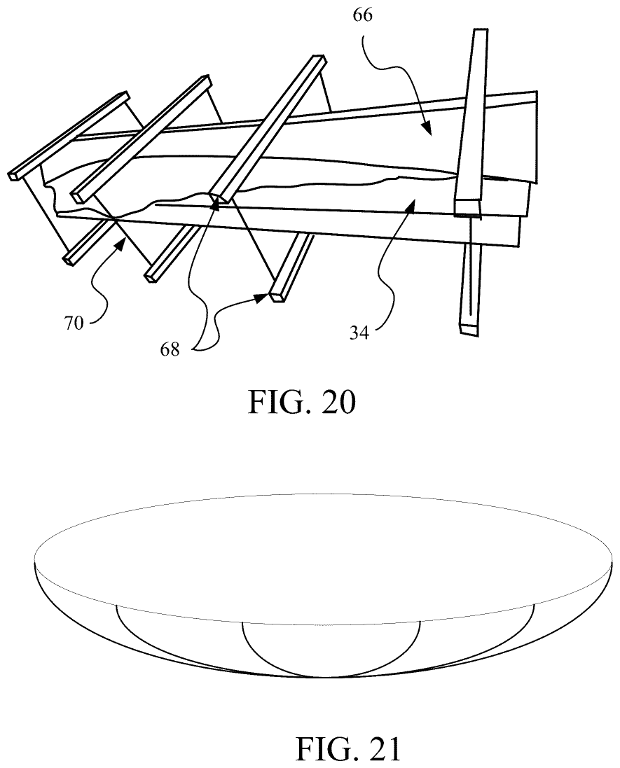

FIG. 20 illustrate an exemplary curing apparatus. A mated mandrel 66 may be positioned on top of the seam. The mated mandrel 66 may include a contoured surface configured to mate with the mating surface. The contoured surface therefore run approximately equal or along the mating surface. The mandrel and the mated mandrel may thereafter be used to retain the relative position of the first panel and the second panel and/or the overlaid material. The curing apparatus may comprise the mandrel 34, the mated mandrel 66 and retainers 68, 70. The retainers may be configured to apply pressure between the mandrel and the mated mandrel and/or simply retain the mandrels in position relative to each other. The retainers 68, 70 as illustrated include cross members 68 that are coupled by joining members 70. The joining members may be configured to permit a variable distance between the cross members such that the cross members may be pulled toward each other and apply pressure between the mandrels.

Exemplary embodiments of the method described herein may include positioning the mated mandrel on the seam over the mandrel. The mated mandrel and the mandrel may be retained to each other. In retaining the mandrel to the mated mandrel, a force or forces may be applied to the mandrel and/or the mated mandrel such that the surfaces of the mandrels apply a pressure on the seam. In an exemplary embodiment, the curing process may also include applying heat, and/or controlling a curing environment (such as limiting humidity). The mandrel and mated mandrel may apply pressure to the seam, with or without the addition of heat, for a period of time. The mandrels may then be separated, and the panels removed. The joined panels may create a section.

The process may then be repeated to add another panel to the second of joined panels. Other pairs of panels may also or alternatively be coupled according to the same methods for the panels described herein. The different sections of joined panels may also be coupled together in the same manner that panels are coupled together. After a series of coupling panels and/or sections together a final three-dimensional surface may be generated.

FIG. 21 illustrates an exemplary embodiment of a resulting three-dimensional surface made of attached two dimensional thin films according to the manufacturing process described herein. The resulting three-dimensional surface defines a highly precise reflective surface.

Exemplary embodiments may be used to define a final three-dimensional surface. The final three-dimensional surface may comprise a material and/or be coated with a material that is reflective, absorptive, or comprise other optical or wave properties, such as for use as reflectors, collectors, satellites, antennas, etc.

In an exemplary embodiment two three dimensional surfaces may be made to create an enclosed volume. The first three-dimensional surface may be made as a high precision surface according to embodiments described herein. The second three-dimensional surface may be a low precision surface or another high precision surface. The second surface may comprise a material that is transmissive and permits the passage of the waves to be reflected, absorbed, collected, etc. by the first three-dimensional surface. In an exemplary embodiment the enclosed volume is inflatable. The system may therefore be inflated to deploy the structure from a collapsed (low volume) configuration to a deployed (in use or larger volume) configuration. The system may comprise other structural components such as an exterior scaffolding to permit additional structure to the desired resulting shape. The scaffolding may be any deployable structure, such as inflatable, telescoping, shape memory, tensioned, etc.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

The invention claimed is:

1. A method, comprising:
cutting a first panel from a sheet of material, the sheet of material is two-dimensional;
cutting a second panel from a second sheet of material, the second sheet of material is two-dimensional;
positioning the first panel on a surface of a mandrel, the surface of the mandrel is three-dimensional;
positioning the second panel on the surface of the mandrel;
repositioning the first panel and/or the second panel so that a gap between the first panel and the second panel is within a tolerance and the first panel and the second panel do not overlap;
securing the first panel to the second panel.

2. The method of claim 1, wherein cutting the first panel comprises positioning a pattern on sheet of material and cutting around a perimeter of the pattern, and cutting the second panel comprises positioning the pattern on the second sheet of material and cutting around the perimeter of the pattern, and the perimeter comprises curved edges.

3. The method of claim 2, further comprising positioning a transparent covering on the first panel; and while the transparent covering is positioned on the first panel, measuring the first panel to confirm the first panel corresponds to the perimeter of the pattern within a given tolerance.

4. The method of claim 3, wherein the pattern comprises one or more slits or openings and the surface of the mandrel comprises a longitudinal marking along a length of the surface of the mandrel and periodic markings perpendicular to the longitudinal marking, and the method further comprises marking the first panel using the one or more slits or openings while the pattern is positioned on the first panel, and wherein positioning the first panel on the mandrel comprises aligning a marking on the first panel to the periodic markings on the surface of the mandrel and aligning an edge of the first panel to the longitudinal marking on the surface of the mandrel.

5. The method of claim 4, wherein the surface of the mandrel comprises a frictional surface to retain the first panel and the second panel in a desired location on the mandrel.

6. The method of claim 5, wherein the surface of the mandrel comprises rubber to frictionally engage the first panel and the second panel, and the method further comprises pressing the first panel and the second panel to the surface of the mandrel to retain the relative positions of the first panel and the second panel to the surface of the mandrel.

7. The method of claim 6, wherein the positioning of the second panel on the mandrel comprises aligning an edge of the second panel to the edge of the first panel and/or the longitudinal marking on the mandrel.

8. The method of claim 1, wherein the repositioning the first panel and/or the second panel comprises inserting a separator between the first panel and/or the second panel and the mandrel to permit relative local movement of the first panel and/or the second panel to the mandrel by separating the frictional contact of the first panel and/or the second panel from the surface of the mandrel.

9. The method of claim 8, wherein the repositioning the first panel and/or the second panel comprises using a magnifying device and micrometer to measure the gap between the first panel and the second panel during the repositioning step.

10. The method of claim 1, wherein the securing the first panel to the second panel comprises adhering a covering material over the edge of the first panel and the edge of the second panel and the gap to create a seam and join the first panel to the second panel.

11. The method of claim 10, wherein the securing the first panel to the second panel comprises applying pressure and/or heat to the seam.

12. The method of claim 11, wherein the mandrel comprises an internal light configured to illuminate through the surface of the mandrel, and the method further comprising using the internal light of the mandrel to assign in an alignment of the first panel and/or the second panel on the surface of the mandrel and confirm that the gap exists between the first panel and the second panel along an entire common length between the first panel and the second panel by observing the light between the first panel and the second panel.

13. The method of claim 12 further comprising repositioning the first panel and the second panel to reduce the gap between the first panel and the second panel.

14. the method of claim 13, wherein the internal light of the mandrel is turned off before the repositioning, and the repositioning is conducted with a magnifier and/or micrometer having an external light used to illuminate the first panel, the second panel, and/or the gap.
